(19) United States
(12) Patent Application Publication
(10) Pub. No.: US 2017/0116311 A1
(43) Pub. Date: Apr. 27, 2017

(54) SYSTEM AND METHOD FOR USE OF AUTOMATIC SLICE MERGE IN A MULTIDIMENSIONAL DATABASE ENVIRONMENT

(71) Applicant: ORACLE INTERNATIONAL CORPORATION, Redwood Shores, CA (US)

(72) Inventors: Roman Reichman, Beer Sheva (IL); Victor Belyaev, San Jose, CA (US); Kumar Ramaiyer, Cupertino, CA (US)

(21) Appl. No.: 15/332,955

(22) Filed: Oct. 24, 2016

Related U.S. Application Data
(60) Provisional application No. 62/245,903, filed on Oct. 23, 2015.
(60) Provisional application No. 62/411,473, filed on Oct. 21, 2016.

(51) Int. Cl. G06F 17/30; G06F 11/14

(52) U.S. Cl. CPC G06F 17/30592; G06F 17/30345; G06F 17/30569; G06F 11/1451; G06F 2201/80

(57) ABSTRACT

In accordance with an embodiment, the system supports automatic slice merge in a multidimensional database computing environment. In a multidimensional database that uses an aggregate storage option container for data storage, the system can create a plurality of slices to support data load transactions, or modifications to the data in response to requests from clients. When the system receives a data update request, for example to update a record within the cube, the system can allow the data to be updated, by writing the updated data to another slice. Subsequently, the system can determine to merge two or more of the slices having modified data, to reduce the overall size of the stored data footprint, and to improve system performance.

### CLAIM OF PRIORITY

This application claims the benefit of priority to U.S. Provisional Application titled “SYSTEM AND METHOD FOR AUTOMATIC SLICE MERGE FUNCTIONALITY FOR USE WITH A MULTIDIMENSIONAL DATABASE”, Application No. 62/245,903, filed Oct. 23, 2015; and U.S. Provisional Application titled “SYSTEM AND METHOD FOR PROVIDING A MULTIDIMENSIONAL DATABASE”, Application No. 62/411,473, filed Oct. 21, 2016; each of which above applications are herein incorporated by reference.

### FIELD OF INVENTION

Embodiments of the invention are generally related to multidimensional database computing environments, and are particularly related to a system and method for use of automatic slice merge in a multidimensional database environment.

### BACKGROUND

Multidimensional database computing environments enable companies to deliver critical business information to the right people when they need it, including the ability to leverage and integrate data from multiple existing data sources, and distribute filtered information to end-user communities in a format that best meets those users' needs. Users can interact with and explore data in real time, and along familiar business dimensions, enabling speed-of-thought analytics. These are some examples of the types of environment in which embodiments of the invention can be used.

### SUMMARY

In accordance with an embodiment, the system supports automatic slice merge in a multidimensional database (e.g., Essbase) computing environment. In a multidimensional database that uses an Aggregate Storage Option (ASO) storage container for data storage, the system can create a plurality of slices to support data load transactions, or modifications to the data in response to requests from clients. When the system receives a data update request, for example to update a record within the cube, the system can allow the data to be updated, by writing the updated data to another slice. Subsequently, the system can determine to merge two or more of the slices having modified data, to reduce the overall size of the stored data footprint, and to improve system performance.

### BRIEF DESCRIPTION OF THE FIGURES:

FIG. 1 illustrates an example of a multidimensional database environment, in accordance with an embodiment.

FIG. 2 illustrates use of automatic slice merge with a multidimensional database, in accordance with an embodiment.

FIG. 3 further illustrates use of automatic slice merge with a multidimensional database, in accordance with an embodiment.

FIG. 4 further illustrates use of automatic slice merge with a multidimensional database, in accordance with an embodiment.

FIG. 5 further illustrates use of automatic slice merge with a multidimensional database, in accordance with an embodiment.

FIG. 6 illustrates a process for use of automatic slice merge with a multidimensional database, in accordance with an embodiment.

### DETAILED DESCRIPTION:

The foregoing, together with other features, will become apparent upon referring to the enclosed specification, claims, and drawings. Specific details are set forth in order to provide an understanding of various embodiments. However, it will be apparent that various embodiments may be practiced without these specific details. The enclosed specification and drawings are not intended to be restrictive.

Multidimensional database environments, an example of which includes Oracle Essbase, can be used to integrate large amounts of data, in some instances from multiple data sources, and distribute filtered information to end-users, in a manner that addresses those users' particular requirements.

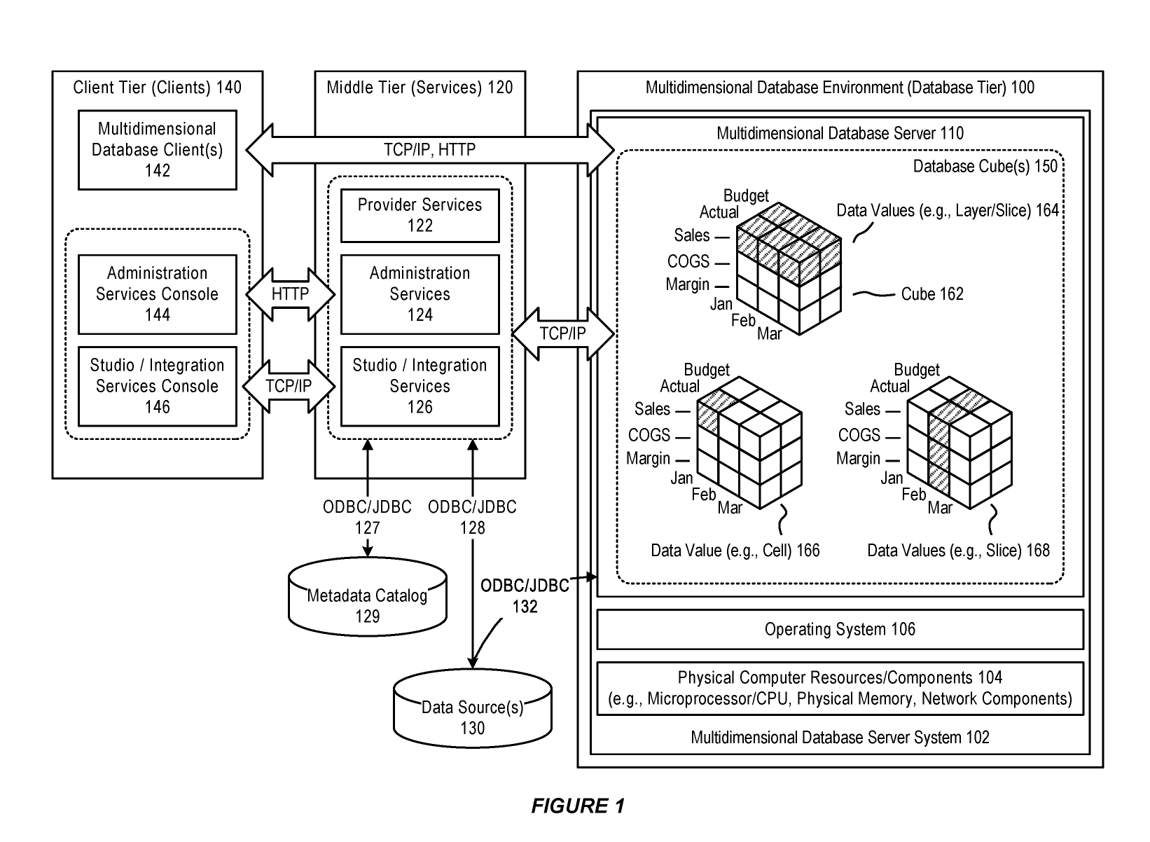

FIG. 1 illustrates an example of a multidimensional database environment 100, in accordance with an embodiment.

As illustrated in FIG. 1, in accordance with an embodiment, a multidimensional database environment, operating as a database tier, can include one or more multidimensional database server system(s) 102, each of which can include physical computer resources or components 104 (e.g., microprocessor/CPU, physical memory, network components), an operating system 106, and one or more multidimensional database server(s) 110 (e.g., Essbase Servers).

In accordance with an embodiment, a middle tier 120 can include one or more service(s), such as, for example, provider services 122 (e.g., Hyperion Provider Services), administration services 124 (e.g., Essbase Administration Services), or studio/integration services 126 (e.g., Essbase Studio/Essbase Integration Services). The middle tier can provide access, via ODBC/JDBC 127, 128, or other types of interfaces, to a metadata catalog 129, and/or one or more data source(s) 130 (for example, a relational database), for use with the multidimensional database environment.

In accordance with an embodiment, the one or more data source(s) can also be accessed, via ODBC/JDBC 132, or other types of interfaces, by the one or more multidimensional database server(s), for use in providing a multidimensional database.

In accordance with an embodiment, a client tier 140 can include one or more multidimensional database client(s) 142 (e.g., Essbase Server clients), that enable access to a multidimensional database (such as, for example, Smart View, Spreadsheet Add-in, Smart Search, Administration Services, MaxL, XMLA, CAPI or VB API Applications, Oracle Business Intelligence Enterprise Edition Plus, or other types of multidimensional database clients). The client tier can also include consoles, for use with services in the middle tier, such as for example an administration services console 144, or a studio/integration services console 146.

In accordance with an embodiment, communication between the client, middle, and database tiers can be provided by one or more of TCP/IP, HTTP, or other types of network communication protocols.

In accordance with an embodiment, the multidimensional database server can integrate data from the one or more data source(s), to provide a multidimensional database, data structure, or cube(s) 150, which can then be accessed to provide filtered information to end-users.

Generally, each data value in a multidimensional database is stored in one cell of a cube; and a particular data value can be referenced by specifying its coordinates along dimensions of the cube. The intersection of a member from one dimension, with a member from each of one or more other dimensions, represents a data value.

For example, as illustrated in FIG. 1, which illustrates a cube 162 that might be used in a sales-oriented business application, when a query indicates “Sales”, the system can interpret this query as a slice or layer of data values 164 within the database that contains all “Sales” data values, where “Sales” intersect with “Actual” and “Budget”. To refer to a specific data value 166 in a multidimensional database, the query can specify a member on each dimension, for example by specifying “Sales, Actual, January”. Slicing the database in different ways, provides different perspectives of the data; for example, a slice of data values 168 for “February” examines all of those data values for which a time/year dimension is fixed for “February”.

### Database Outline

In accordance with an embodiment, development of a multidimensional database begins with the creation of a database outline, which defines structural relationships between members in the database; organizes data in the database; and defines consolidations and mathematical relationships. Within the hierarchical tree or data structure of the database outline, each dimension comprises one or more members, which in turn may comprise other members. The specification of a dimension instructs the system how to consolidate the values of its individual members. A consolidation is a group of members within a branch of the tree.

### Dimensions and Members

In accordance with an embodiment, a dimension represents the highest consolidation level in the database outline. Standard dimensions may be chosen to represent components of a business plan that relate to departmental functions (e.g., Time, Accounts, Product Line, Market, Division). Attribute dimensions, that are associated with standard dimensions, enable a user to group and analyze members of standard dimensions based on member attributes or characteristics. Members (e.g., Product A, Product B, Product C) are the individual components of a dimension.

### Dimension and Member Relationships

In accordance with an embodiment, a multidimensional database uses family (parents, children, siblings; descendants and ancestors); and hierarchical (generations and levels; roots and leaves) terms, to describe the roles and relationships of the members within a database outline.

In accordance with an embodiment, a parent is a member that has a branch below it. For example, “Margin” may be a parent for “Sales”, and “Cost of Goods Sold” (COGS). A child is a member that has a parent above it. In the above example, “Sales” and “Cost of Goods Sold” are children of the parent “Margin”. Siblings are children of the same immediate parent, within the same generation.

In accordance with an embodiment, descendants are members in branches below a parent. For example, “Profit”, “Inventory”, and “Ratios” may be descendants of Measures; in which case the children of “Profit”, “Inventory”, and “Ratios” are also descendants of Measures. Ancestors are members in branches above a member. In the above example, “Margin”, “Profit”, and Measures may be ancestors of “Sales”.

In accordance with an embodiment, a root is the top member in a branch. For example, Measures may be the root for “Profit”, “Inventory”, and “Ratios”; and as such for the children of “Profit”, “Inventory”, and “Ratios”. Leaf (level 0) members have no children. For example, Opening “Inventory”, Additions, and Ending “Inventory” may be leaf members.

In accordance with an embodiment, a generation refers to a consolidation level within a dimension. The root branch of the tree is considered to be “generation 1”, and generation numbers increase from the root toward a leaf member. Level refers to a branch within a dimension; and are numbered in reverse from the numerical ordering used for generations, with level numbers decreasing from a leaf member toward its root.

In accordance with an embodiment, a user can assign a name to a generation or level, and use that name as a shorthand for all members in that generation or level.

### Sparse and Dense Dimensions

Data sets within a multidimensional database often share two characteristics: the data is not smoothly and uniformly distributed; and data does not exist for a majority of member combinations.

In accordance with an embodiment, to address this, the system can recognize two types of standard dimensions: sparse dimensions and dense dimensions. A sparse dimension is one with a relatively low percentage of available data positions filled; while a dense dimension is one in which there is a relatively high probability that one or more cells is occupied in every combination of dimensions. Many multidimensional databases are inherently sparse, in that they lack data values for the majority of member combinations.

### Data Blocks and the Index System

In accordance with an embodiment, the multidimensional database uses data blocks and an index to store and access data. The system can create a multidimensional array or data block for each unique combination of sparse standard dimension members, wherein each data block represents the dense dimension members for its combination of sparse dimension members. An index is created for each data block, wherein the index represents the combinations of sparse standard dimension members, and includes an entry or pointer for each unique combination of sparse standard dimension members for which at least one data value exists.

In accordance with an embodiment, when the multidimensional database server searches for a data value, it can use the pointers provided by the index, to locate the appropriate data block; and, within that data block, locate the cell containing the data value.

### Administration Services

In accordance with an embodiment, an administration service (e.g., Essbase Administration Services) provides a single-point-of-access that enables a user to design, develop, maintain, and manage servers, applications, and databases.

### Studio

In accordance with an embodiment, a studio (e.g., Essbase Studio) provides a wizard-driven user interface for performing tasks related to data modeling, cube designing, and analytic application construction.

### Spreadsheet Add-in

In accordance with an embodiment, a spreadsheet add-in integrates the multidimensional database with a spreadsheet, which provides support for enhanced commands such as Connect, Pivot, Drill-down, and Calculate.

### Integration Services

In accordance with an embodiment, an integration service (e.g., Essbase Integration Services), provides a metadata-driven environment for use in integrating between the data stored in a multidimensional database and data stored in relational databases.

### Provider Services

In accordance with an embodiment, a provider service (e.g., Hyperion Provider Services) operates as a data-source provider for Java API, Smart View, and XMLA clients.

### Smart View

In accordance with an embodiment, a smart view provides a common interface for, e.g., Hyperion Financial Management, Hyperion Planning, and Hyperion Enterprise Performance Management Workspace data.

### Developer Products

In accordance with an embodiment, developer products enable the rapid creation, management, and deployment of tailored enterprise analytic applications.

### Lifecycle Management

In accordance with an embodiment, a lifecycle management (e.g., Hyperion Enterprise Performance Management System Lifecycle Management) provides a means for enabling enterprise performance management products to migrate an application, repository, or individual artifacts across product environments.

### Olap

In accordance with an embodiment, online analytical processing (OLAP) provides an environment that enables users to analyze enterprise data. For example, finance departments can use OLAP for applications such as budgeting, activity-based costing, financial performance analysis, and financial modeling, to provide “just-in-time” information.

### Automatic Slice Merge Functionality

In accordance with an embodiment, the system supports automatic slice merge in a multidimensional database (e.g., Essbase) computing environment. In a multidimensional database that uses an Aggregate Storage Option (ASO) storage container for data storage, the system can create a plurality of slices to support data load transactions, or modifications to the data in response to requests from clients. When the system receives a data update request, for example to update a record within the cube, the system can allow the data to be updated, by writing the updated data to another slice. Subsequently, the system can determine to merge two or more of the slices having modified data, to reduce the overall size of the stored data footprint, and to improve system performance.

ASO-type storage containers are particular useful in providing data to run reports, but are not as well suited to allowing updates to the data. However, some user of ASO-type storage containers may want the ability to make modifications to their data, and as such multidimensional database systems generally support such modifications.

In accordance with an embodiment, in order to enable modifications to the data in a ASO-type storage container, in response to a request to update a particular cell, the system can create slices of the database that include the update(s) to those cells.

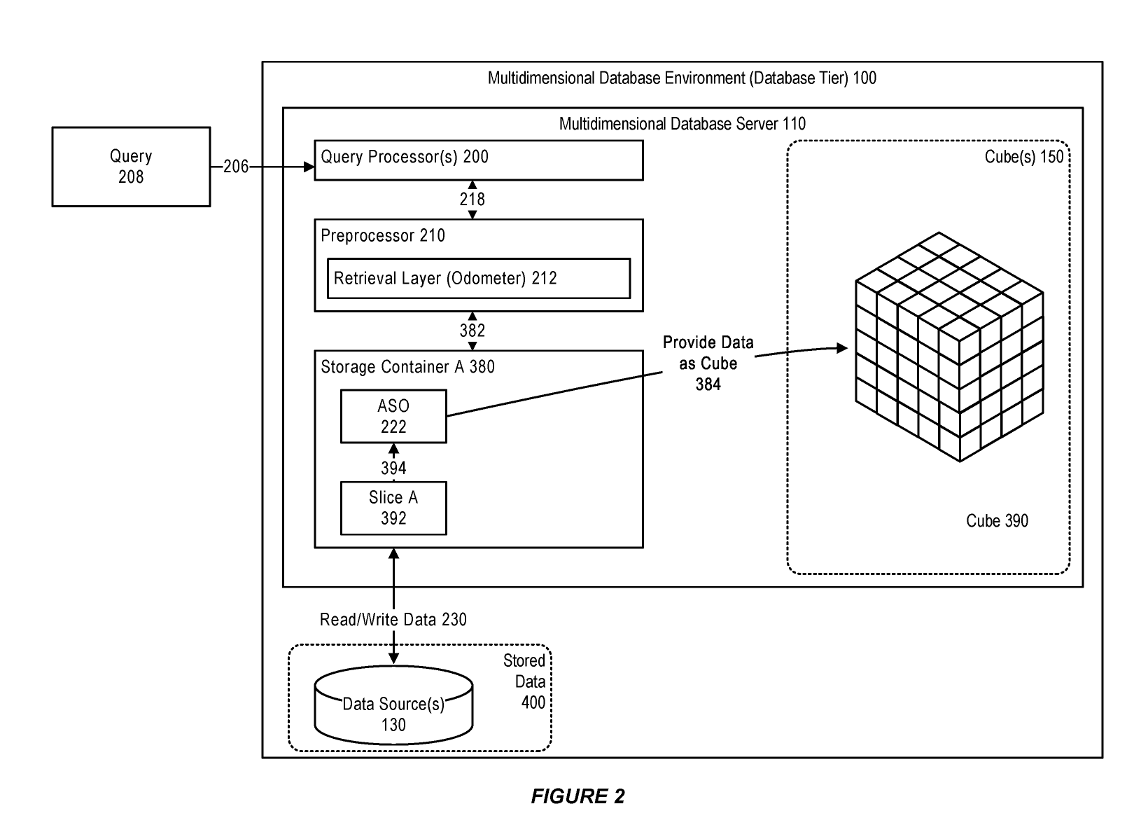

FIG. 2 illustrates use of automatic slice merge with a multidimensional database, in accordance with an embodiment.

As illustrated in FIG. 2, in accordance with an embodiment, the system can include one or more query processor(s) 200, for example a Multidimensional Expressions (MDX) query processor, and/or a SpreadSheet Extractor (SSE) query processor, that enable receipt 206 of an input query 208 from a client, to retrieve, access, or otherwise examine a set of data from a data source, as provided by and made accessible via the multidimensional database.

In accordance with an embodiment, a preprocessor component 210 can include a data retrieval layer 212 or data fetching component (which in some environments can incorporate a kernel-based odometer retriever, or odometer that manages pointers to data blocks, contains control information, or otherwise acts as an array of arrays of pointers to stored members), each of which layers and components can be provided as a software or program code that is executable by a computer system.

Generally, described, in accordance with an embodiment, the preprocessor receives 218 input queries, from the one or more query processor(s), for processing against the multidimensional database.

In accordance with an embodiment, the system can include a storage container A 380, such as, for example, an Aggregate Storage Option (ASO) 222 storage container which acts as an interface between the data that is read from/written to 230 the data source or multidimensional database, and whichever data 382 might be needed by the preprocessor in creating or populating the data 384 for a cube 390.

In accordance with an embodiment, instead of a single storage container instance, the preprocessor and data retrieval layer can use two or more storage container instances. The first time the system accesses the data from a data source, it can provide that data in one slice 392, which in this example is provided 394 to storage container instance A.

As illustrated in FIG. 2, at this point, the stored data 400 is maintained in one slice, by one storage container.

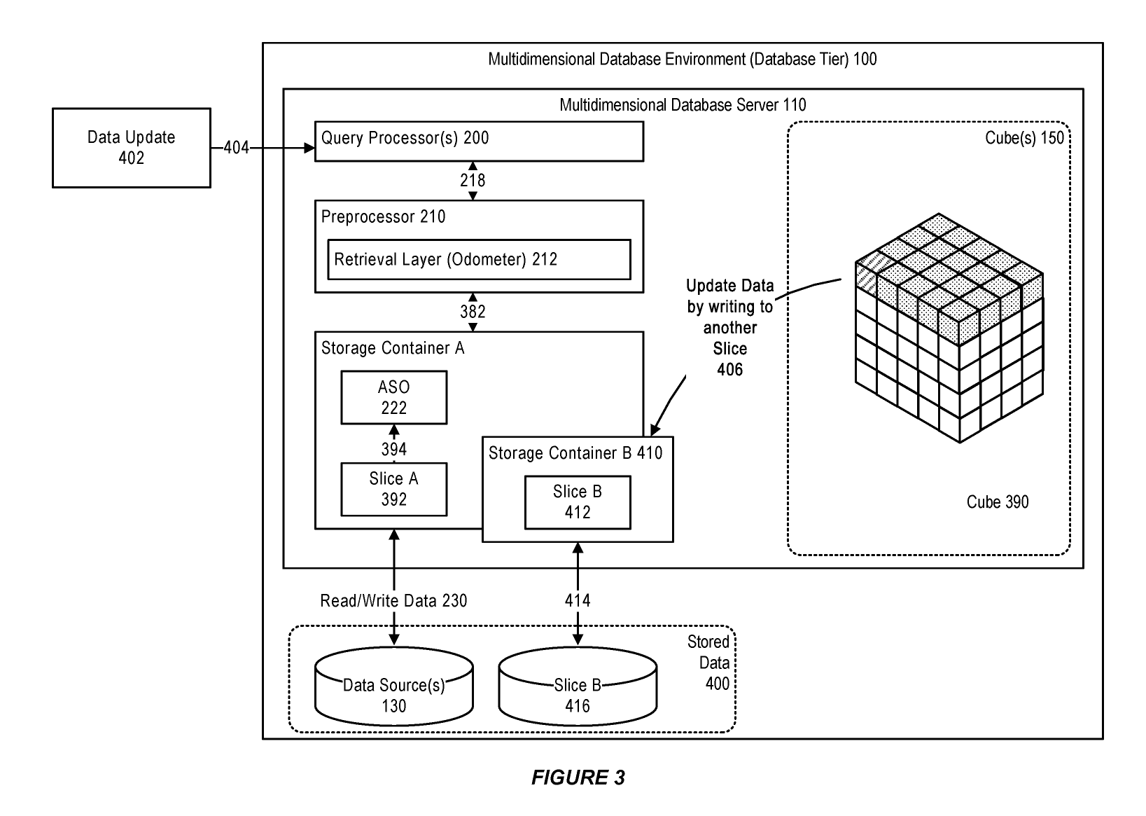

FIG. 3 further illustrates use of automatic slice merge with a multidimensional database, in accordance with an embodiment.

As illustrated in FIG. 3, in accordance with an embodiment, when the system receives a data update request 402, for example to update a record within the cube, the system can allow the data to be updated 404, by writing the updated data to another slice 406 (i.e., a second slice in this example), which in this example is associated with a (second) storage container instance B 410, and second slice B412, which is then stored 414 as the slice 416 in the stored data.

As illustrated in FIG. 3, at this point, the stored data is maintained in two slices, by two storage container instances.

When a next query is received for the data associated with the plurality of slices, the system can obtain the data from, in this example, the first and second slices, and add the data together, to create the response.

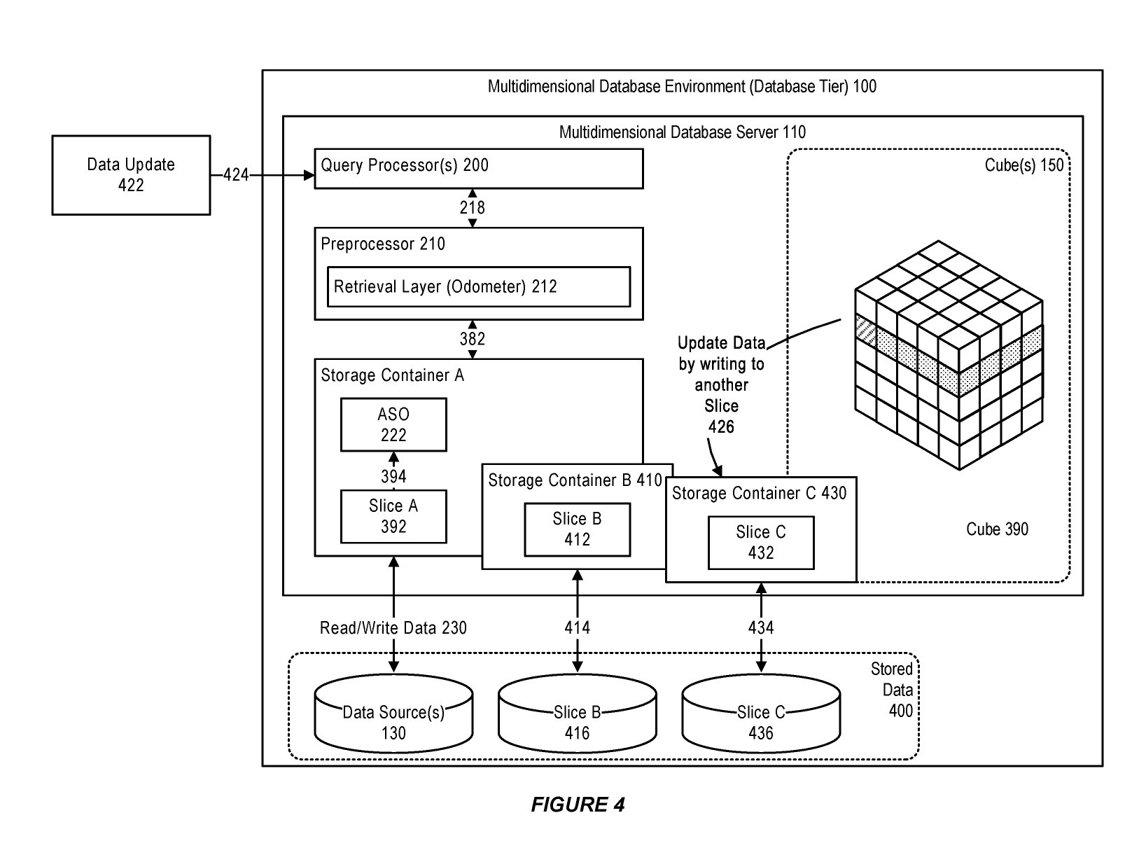

FIG. 4 further illustrates use of automatic slice merge with a multidimensional database, in accordance with an embodiment.

As illustrated in FIG. 4, in accordance with an embodiment, when the system receives another data update request 422, for example to update another record within the cube, the system can again allow the data to be updated 424, by writing the updated data to yet another slice 426 (i.e., a third slice in this example), which in this example is associated with a (third) storage container C430 and slice B432, and then stored 434 as the slice 436 in the stored data.

As illustrated in FIG. 4, at this point, the stored data is maintained in three slices, by three storage container instances.

When a next query is received for the data associated with the plurality of slices, the system can similarly obtain the data from, in this example, the first, second, and third slices, and add the data together to create the response.

Generally, the system can support any number of slices. However, a problem arises when the amount and types of slices causes inefficiency in processing the response. For example, a slice having 1 million cells, together with another slice having 10 cells, may be performed efficiently. However, a slice having 1 million cells, together with another slice having 1 million cells, may be very inefficient.

In accordance with an embodiment, to address this, the system can determine when and how to merge two or more slices into a single slice.

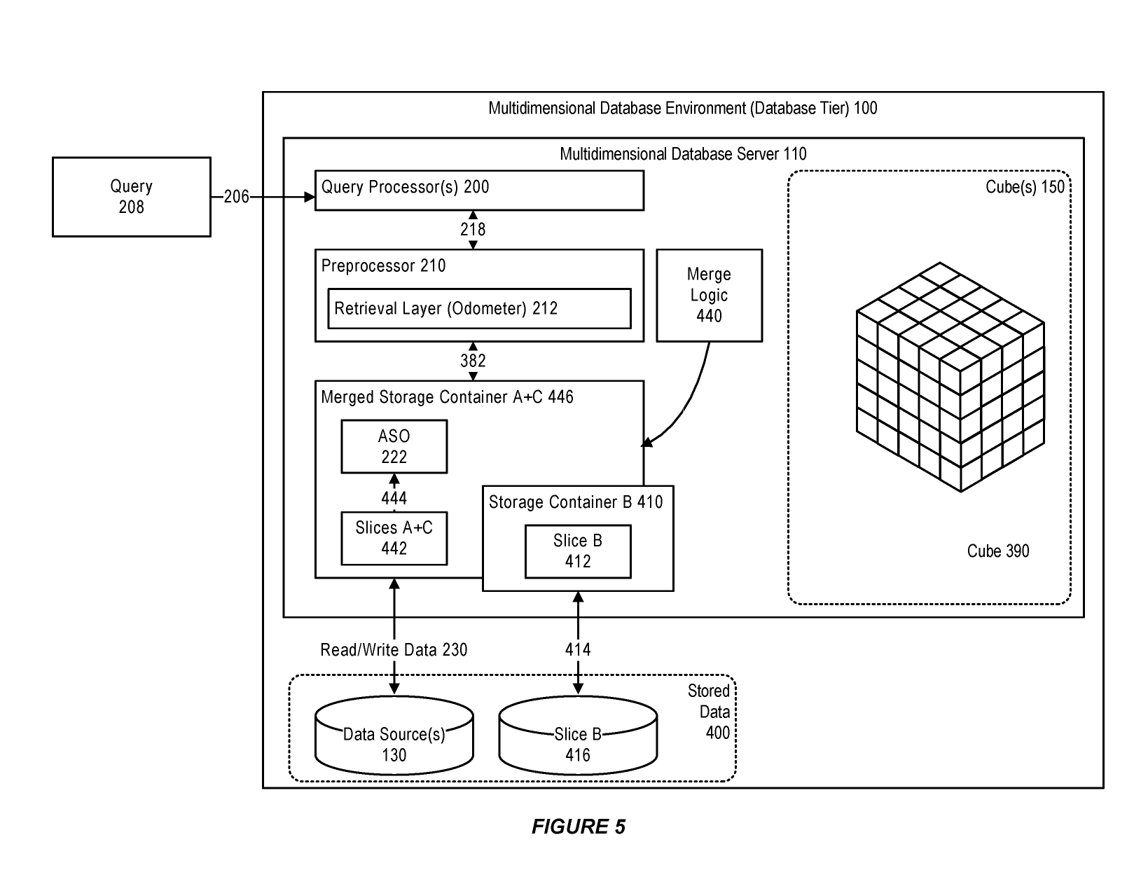

FIG. 5 further illustrates use of automatic slice merge with a multidimensional database, in accordance with an embodiment.

As illustrated in FIG. 5, in accordance with an embodiment, a merge logic 440 can determine, based on the comparable sizes of the plurality of slices, whether to merge two or more slices, including, in this example, to merge a plurality of slices A and C (442), such that they are again accessed 444 as a single (A+C) slice, and associated with a single or merged (A+C) storage container 446.

In accordance with an embodiment, the system supports automatically merging incremental data slices during a data load to an aggregate storage database. Using the AUTOMERGE and AUTOMERGEMAXSLICENUMBER configuration settings, an administrator or other user can specify whether a multidimensional database (e.g., Essbase) environment automatically merges incremental data slices during a data load to an aggregate storage database.

In accordance with an embodiment, AUTOMERGE configuration setting options include:

ALWAYS—Specifies to automatically merge incremental data slices during a data load to an aggregate storage database. In accordance with an embodiment, by default, merges are executed once for every four consecutive incremental data slices. If, however, the AUTOMERGEMAXSLICENUMBER configuration setting is used, the auto-merge process is activated when the AUTOMERGEMAXSLICENUMBER value is exceeded. The size of the incremental data slices is not a factor in selecting which ones are merged. In accordance with an embodiment, the default value is ALWAYS.

NEVER—Specifies to never automatically merge incremental data slices during a data load to an aggregate storage database. To manually merge incremental data slices, use the alter database MaxL statement with the merge grammar.

SELECTIVE—Specifies to activate the incremental data slice auto-merge process when the number of incremental data slices specified in the AUTOMERGEMAXSLICENUMBER configuration setting is exceeded. If the number of incremental data slices in the data load does not exceed the value of AUTOMERGEMAXSLICENUMBER, the auto-merge process is not activated.

In accordance with an embodiment, an example syntax can include:

In accordance with an embodiment, an administrator or other user can merge all incremental data slices into the main database slice or merge all incremental data slices into a single data slice while leaving the main database slice unchanged. To merge slices, they must have the same privileges as for loading data (e.g., Administrator or Database Manager permissions). After the new input view is written to the database, the system creates aggregate views for the slice. The views created for the new slice are a subset of the views that exist on the main database slice.

In accordance with an embodiment, if an administrator or other user has cleared data from a region using the logical clear region operation, which results in a value of zero for the cells cleared, they can elect to remove zero value cells during the merge operation.

To perform merging operations, the user can use an alter database MaxL statement with a merge grammar. For example, to merge all incremental data slices into the main database slice, this statement can be used:
alter database ASOsamp.Sample merge all data;

To merge all incremental data slices into the main database slice and remove zero value cells, this statement can be used:
alter database ASOsamp.Sample merge all data remove_zero_cells;

To merge all incremental data slices into a single data slice, this statement can be used:
alter database ASOsamp.Sample merge incremental data;

Before copying an aggregate storage application, all incremental data slices should be merged into the main database slice; since data in unmerged incremental data slices is not copied.

For example, in accordance with an embodiment,
AUTOMERGE SELECTIVE

Specifies that the value of the AUTOMERGEMAXSLICENUMBER configuration setting determines whether the process of automatically merging incremental data slices is activated.

In accordance with an embodiment, the AUTOMERGEMAXSLICENUMBER configuration setting specifies the maximum number of incremental data slices that can exist in a data load without activating the process of automatically merging incremental data slices. When the value of AUTOMERGEMAXSLICENUMBER is exceeded, the auto-merge process is activated.

In accordance with an embodiment, to use the AUTOMERGEMAXSLICENUMBER configuration setting, the AUTOMERGE configuration setting must be set to SELECTIVE or ALWAYS. This setting applies only to aggregate storage databases. An example syntax can include:
AUTOMERGEMAXSLICENUMBER n

Where n specifies the maximum number of incremental data slices that can exist in a data load without activating the process of automatically merging incremental data slices.

In accordance with an embodiment, when the number of incremental data slices is equal to (=) or less than (<) n, the incremental data slices are not merged. When the number of incremental data slices is greater than (>) n, the auto-merge process is activated. In accordance with an embodiment, the default value is 4.

In accordance with an embodiment, during the auto-merge process, the system determines the maximum size, as a percentage, that any one incremental data slice can contribute to the maximum number of incremental input cells; and counts the number of cells in all committed incremental data slices. If r represents the maximum percentage, then if the size of an incremental data slice, as a percentage, is:

Equal to or less than r, the incremental data slice is added to the list of incremental data slices to be automatically merged;

Greater than r, the incremental data slice is not added to the list of incremental data slices to be automatically merged.

For example, in accordance with an embodiment,
AUTOMERGEMAXSLICENUMBER 5

Activates the incremental data slice auto-merge process when the number of incremental data slices exceeds 5.

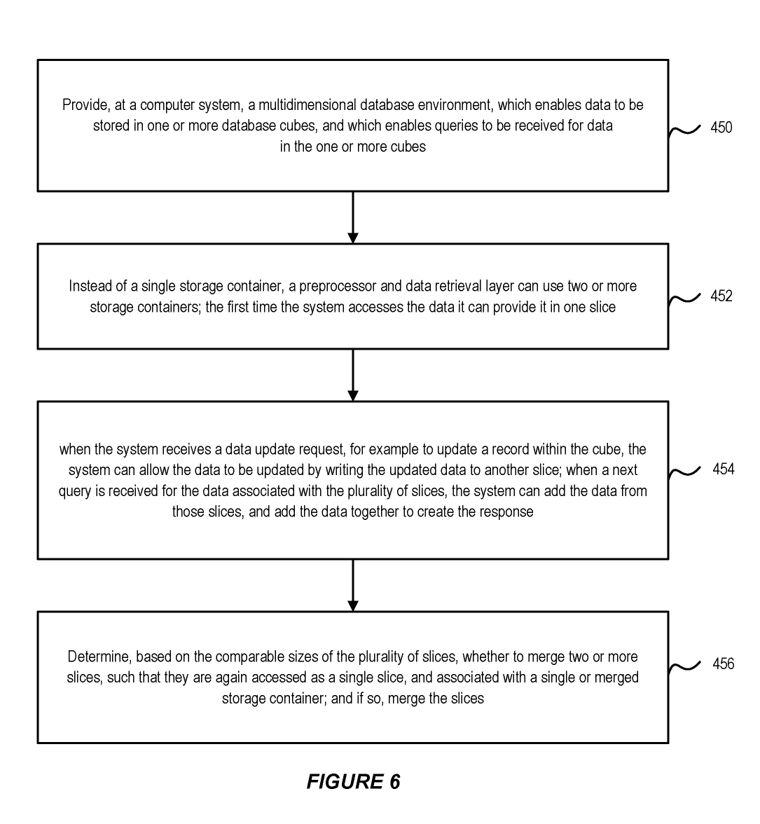

FIG. 6 illustrates a process for use of automatic slice merge with a multidimensional database, in accordance with an embodiment.

As illustrated in FIG. 6, in accordance with an embodiment, at step 450, a multidimensional database environment is provided at a computer system, which enables data to be stored in one or more database cubes, and which enables queries to be received for data in the one or more cubes.

At step 452, instead of a single storage container, the preprocessor and data retrieval layer can use two or more storage containers; the first time the system accesses the data it can provide it in one slice.

At step 454, when the system receives a data update request, for example to update a record within the cube, the system can allow the data to be updated by writing the updated data to another slice; when a next query is received for the data associated with the plurality of slices, the system can add the data from those slices, and add the data together to create the response.

At step 456, a determination is made, based on the comparable sizes of the plurality of slices, whether to merge two or more slices, such that they are again accessed as a single slice, and associated with a single or merged storage container; and if so, the slices are merged.

The present invention may be conveniently implemented using one or more conventional general purpose or specialized computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the present invention includes a computer program product which is a non-transitory storage medium or computer readable medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

The foregoing description of the present invention has been provided for the purposes of illustration and description. It is not intended to be exhaustive or to limit the invention to the precise forms disclosed. Many modifications and variations will be apparent to the practitioner skilled in the art.

For example, while many of the embodiments described herein illustrate the use of an Oracle Essbase multidimensional database environment, in accordance with various embodiments the components, features, and methods described herein can be used with other types of online analytical processing or multidimensional database computing environments.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalents.

What is claimed is:

1. A system for use of automatic slice merge in a multidimensional database environment, comprising:
a computing, including a processor;
a multidimensional database, for at least one of storage or analysis of data; and
wherein the system includes an automatic slice merge functionality that controls when the multidimensional database environment merges incremental data slices, associated with a cube, during a data load to an aggregate storage database.

2. The system of claim 1, wherein the system creates a plurality of data slices to support data load transactions, or modifications to the data in response to requests from clients; and
whereupon the system receiving a data update request, to update a record within the cube, the system allows the data to be updated by writing an updated data to another data slice.

3. The system of claim 2, wherein the system subsequently determines to merge two or more of data slices having modified data, to reduce the overall size of the stored data footprint.

4. The system of claim 1, wherein slices are created for use with an aggregate storage option container to support transactions of data, and wherein the system subsequently makes a determination whether to merge the slices.

5. The system of claim 1, wherein the system enables a user to specify a merge of all incremental data slices into a main database slice, or a merge of all incremental data slices into a single data slice, while leaving a main database slice unchanged.

6. A method for use of automatic slice merge in a multidimensional database environment, comprising:
providing, at a computer system including a processor, a multidimensional database, for at least one of storage or analysis of data; and
performing an automatic slice merge process that controls when the multidimensional database environment merges incremental data slices, associated with a cube, during a data load to an aggregate storage database.

7. The method of claim 6, wherein the system creates a plurality of data slices to support data load transactions, or modifications to the data in response to requests from clients; and
whereupon the system receiving a data update request, to update a record within the cube, the system allows the data to be updated by writing an updated data to another data slice.

8. The method of claim 7, wherein the system subsequently determines to merge two or more of data slices having modified data, to reduce the overall size of the stored data footprint.

9. The method of claim 6, wherein slices are created for use with an aggregate storage option container to support transactions of data, and wherein the system subsequently makes a determination whether to merge the slices.

10. The method of claim 6, wherein the system enables a user to specify a merge of all incremental data slices into a main database slice, or a merge of all incremental data slices into a single data slice, while leaving a main database slice unchanged.

11. A non-transitory computer readable storage medium, including instructions stored thereon which when read and executed by one or more computers cause the one or more computers to perform the steps comprising:
providing, at a computer system, a multidimensional database, for at least one of storage or analysis of data; and
performing an automatic slice merge process that controls when the multidimensional database environment merges incremental data slices, associated with a cube, during a data load to an aggregate storage database.

12. The non-transitory computer readable storage medium of claim 11, wherein the system creates a plurality of data slices to support data load transactions, or modifications to the data in response to requests from clients; and
whereupon the system receiving a data update request, to update a record within the cube, the system allows the data to be updated by writing an updated data to another data slice.

13. The non-transitory computer readable storage medium of claim 12, wherein the system subsequently determines to merge two or more of data slices having modified data, to reduce the overall size of the stored data footprint.

14. The non-transitory computer readable storage medium of claim 11, wherein slices are created for use with an aggregate storage option container to support transactions of data, and wherein the system subsequently makes a determination whether to merge the slices.

15. The non-transitory computer readable storage medium of claim 11, wherein the system enables a user to specify a merge of all incremental data slices into a main database slice, or a merge of all incremental data slices into a single data slice, while leaving a main database slice unchanged.
